(19) United States
(12) Patent Application Publication
(10) Pub. No.: US 2026/0255304 A1
(43) Pub. Date: Aug. 27, 2026

(54) POSITIONING USING NETWORK-CONTROLLED REPEATER

(71) Applicant: QUALCOMM Incorporated, San Diego, CA (US)

(72) Inventors: Bapineedu Chowdary GUMMADI, Hyderabad (IN); Stephen William EDGE, Escondido, CA (US)

(21) Appl. No.: 19/061,749

(22) Filed: Feb. 24, 2025

(51) Int. Cl. H04W 64/00; H04L 5/00; H04W 8/22

(52) U.S. Cl. CPC H04W 64/00; H04L 5/0051; H04W 8/22

(57) ABSTRACT

Aspects presented herein may enable a network entity (e.g., a location server, a location management function (LMF), etc.) to provide configurations related to network-controlled repeater (NCR), thereby improving the overall performance and accuracy of network-based positioning that utilizes one or more NCRs. For example, in one aspect of the present disclosure, a network entity receives an indication that an NCR is available for a positioning session of a user equipment (UE). The network entity receives capability information related to the NCR. The network entity transmits a configuration for transmitting a set of reference signals (RSs) to the UE using the NCR, where the configuration is based on availability and capability information of the NCR.

### TECHNICAL FIELD

The present disclosure relates generally to communication systems, and more particularly, to wireless communication involving positioning and sensing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some telecommunication standards also provide positioning protocols and techniques that enable mobile network operators to provide high-accuracy location services to their subscribers. For example, 5G NR include various standards for network-based positioning that use signals and features of the 5G network to perform or improve the positioning of a device. There also exists a need for further improvements in these positioning protocols and techniques.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives an indication that a network-controlled repeater (NCR) is available for a positioning session of a user equipment (UE). The apparatus receives capability information related to the NCR. The apparatus transmits a configuration for transmitting a set of reference signals (RSs) to the UE using the NCR, where the configuration is based on availability and capability information of the NCR.

In an aspect of the disclosure, a method, a computer-readable medium, and an apparatus are provided. The apparatus transmits, to a first network entity, an indication that an NCR is available for a positioning session of a UE. The apparatus transmits, to the first network entity, capability information related to the NCR. The apparatus receives, from the first network entity, a configuration for transmitting a set of RSs to the UE using the NCR, where the configuration is based on availability and capability information of the NCR.

In an aspect of the disclosure, a method, a computer-readable medium, and an apparatus are provided. The apparatus receives, from a first network entity or a second network entity, a configuration for transmitting a set of RSs to a UE. The apparatus transmits the set of RSs to the UE based on the configuration. The apparatus transmits, to the first network entity or the second network entity, at least one of delay information or an angle of departure (AoD) associated with transmission of the set of RSs.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements (which may also be referred to as “network-based positioning”) in accordance with various aspects of the present disclosure.

FIG. 5A is a diagram illustrating an example conceptual model of a network-controlled repeater (NCR) in accordance with various aspects of the present disclosure.

FIG. 5B is a diagram illustrating an example conceptual model of an NCR in accordance with various aspects of the present disclosure.

FIG. 6 is a diagram illustrating an example of a base station activating and/or deactivating an NCR in accordance with various aspects of the present disclosure.

FIG. 7A is a diagram illustrating an example of signal timing delay due to NCR in accordance with various aspects of the present disclosure.

FIG. 7B is a diagram illustrating an example of signal timing delay due to NCR in accordance with various aspects of the present disclosure.

FIG. 8 is a communication flow illustrating an example signaling for sharing NCR information between different entities for positioning in accordance with various aspects of the present disclosure.

FIG. 9 is a flowchart of a method of wireless communication.

FIG. 10 is a diagram illustrating an example of a hardware implementation for an example network entity.

FIG. 11 is a flowchart of a method of wireless communication.

FIG. 12 is a diagram illustrating an example of a hardware implementation for an example network entity.

FIG. 13 is a flowchart of a method of wireless communication.

FIG. 14 is a diagram illustrating an example of a hardware implementation for an example apparatus and/or network entity.

### DETAILED DESCRIPTION

Aspects presented herein may improve the overall performance and accuracy of positioning that utilizes one or more network-controlled repeaters (NCRs), such as for network-based positioning that utilizes at least one NCR. Aspects presented herein may enable delays associated with NCR(s) to be considered when NCR(s) are used for (assisting) positioning of a user equipment (UE). For example, in one aspect of the present disclosure, when one or more NCRs are used by a base station for positioning of a UE, the location server (e.g., the location management function (LMF)) may be specified to be aware/notified of the presence of the NCR(s), and provide positioning configurations that are related to the NCR(s), such as providing configuration(s) for the NCR(s) and/or addressing delays related to the NCR(s) (e.g., taking the delay into consideration when estimating the location of the UE). In other words, as positioning configuration from the location server may be configured with the presence of NCR, the location server is expected to be aware of the NCR.

With the assistance of the side control information, NCRs may perform the amplify-and-forward operations in a more efficient manner prompting them to be easily deployed and used for a great benefit. For example, it may be beneficial to deploy NCRs when there is no sufficient coverage or there are coverage gaps like rural, buildings, cellars, etc. In addition, NCRs may also be used to extend the applicability of the network-based positioning. For example, if a network entity (e.g., a base station) is unable to transmit reference signals (e.g., positioning reference signals (PRSs)) directly to a UE and/or receive reference signals (e.g., sounding reference signals (SRSs)) directly from the UE for positioning of the UE due to the range between the network entity and the UE, the network entity may try to deploy an NCR between the network entity and the UE to forward the reference signals. As such, the network entity and the UE may still achieve/perform the network-based positioning based on using the NCR. However, when a network-based positioning session includes using at least one NCR for positioning, the internal delay(s) of the at least one NCR may cause some inaccuracy in the positioning. Thus, network-based positioning (or other types of positioning) may demand additional considerations when NCR(s) are deployed for the positioning.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

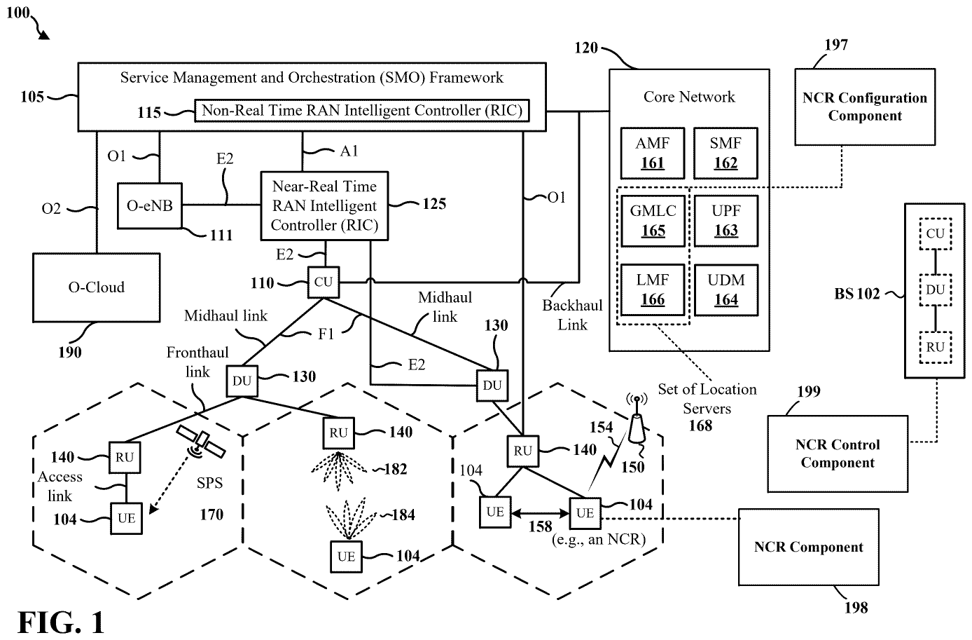

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via dataset collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHz-7.125 GHz) and FR2 (24.25 GHz-52.6 GHz). Although a portion of FRI is greater than 6 GHz, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, the network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smartphone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 (serving an a network-controlled repeater (NCR)) may have an NCR component 198 that may be configured to receive, from a first network entity or a second network entity, a configuration for transmitting a set of RSs to a UE; transmit the set of RSs to the UE based on the configuration; and transmit, to the first network entity or the second network entity, at least one of delay information or an AoD associated with transmission of the set of RSs. In certain aspects, the base station 102 may have an NCR control component 199 that may be configured to transmit, to a first network entity, an indication that an NCR is available for a positioning session of a UE; transmit, to the first network entity, capability information related to the NCR; and receive, from the first network entity, a configuration for transmitting a set of RSs to the UE using the NCR, where the configuration is based on availability and capability information of the NCR. In certain aspects, the one or more location servers 168 may have an NCR configuration component 197 that may be configured to receive an indication that an NCR is available for a positioning session of a UE; receive capability information related to the NCR; and transmit a configuration for transmitting a set of RSs to the UE using the NCR, where the configuration is based on availability and capability information of the NCR.

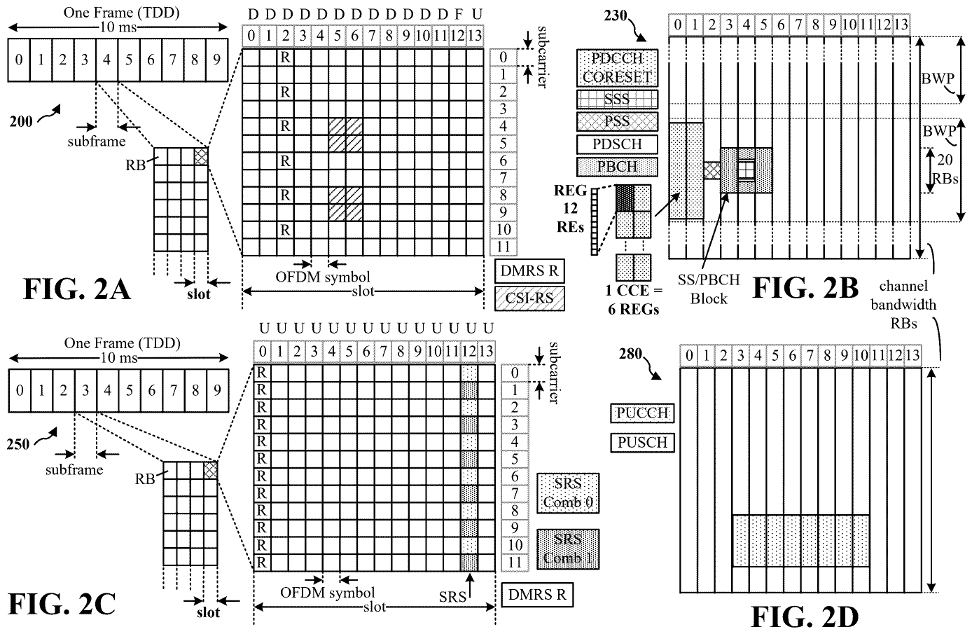

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

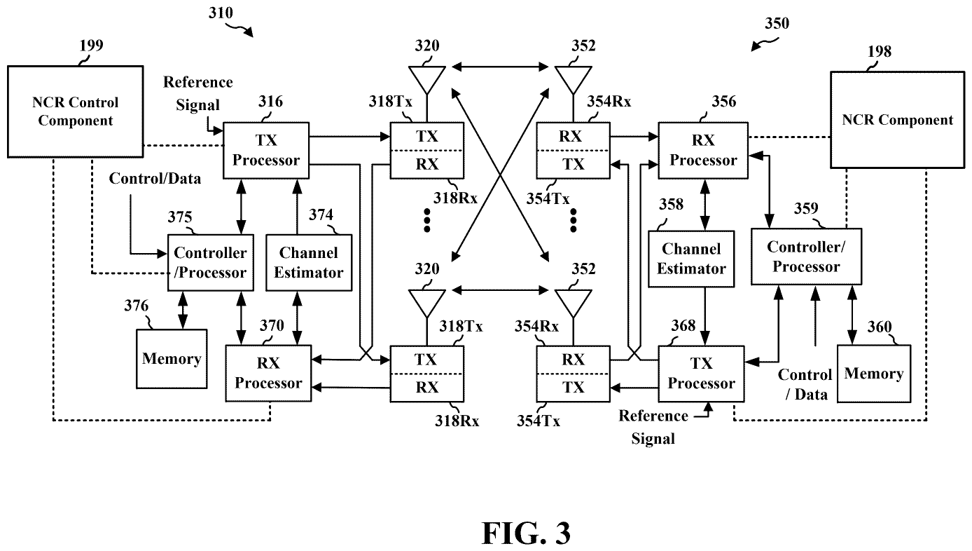

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the NCR component 198 of FIG. 1.

At least one of the TX processor 316, the RX processor 370, and the controller/processor 375 may be configured to perform aspects in connection with the NCR control component 199 of FIG. 1.

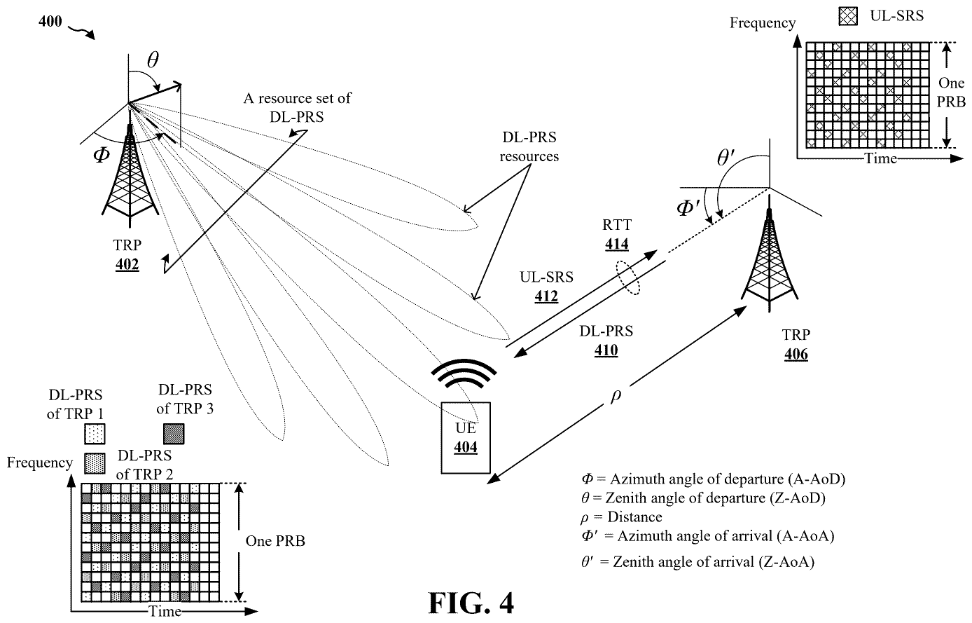

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_-RX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS-TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS-TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402,406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402,406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

For purposes of the present disclosure, “UE Rx−Tx time difference” may be defined as T_{UE-RX}−T_{UE-TX}, where: T_{UE-RX} is the UE received timing of downlink subframe #i from a Transmission Point (TP), defined by the first detected path in time. Tu_{F}-rx is the UE transmit timing of uplink subframe #j that is closest in time to the subframe #i received from the TP. Multiple DL PRS or CSI-RS for tracking resources, as instructed by higher layers, can be used to determine the start of one subframe of the first arrival path of the TP. For frequency range 1, the reference point for T_{uF}ax measurement may be the Rx antenna connector of the UE and the reference point for T_{UE-TX} measurement may be the Tx antenna connector of the UE. For frequency range 2, the reference point for T_{UE-RX} measurement may be the Rx antenna of the UE and the reference point for T_{UE-TX} measurement may be the Tx antenna of the UE.

“DL reference signal time difference (DL RSTD)” is the DL relative timing difference between the Transmission Point (TP) j and the reference TP i, defined as T_{SubframeRxj}−T_{SubframeRxi}, where: T_{SubframeRxj} is the time when the UE receives the start of one subframe from TP j. T_{SubfraneRxi} is the time when the UE receives the corresponding start of one subframe from TP i that is closest in time to the subframe received from TP j. Multiple DL PRS resources can be used to determine the start of one subframe from a TP. For frequency range 1, the reference point for the DL RSTD may be the antenna connector of the UE. For frequency range 2, the reference point for the DL RSTD may be the antenna of the UE.

“DL PRS reference signal received power (DL PRS-RSRP),” is defined as the linear average over the power contributions (in [W]) of the resource elements that carry DL PRS reference signals configured for RSRP measurements within the considered measurement frequency bandwidth. For frequency range 1, the reference point for the DL PRS-RSRP may be the antenna connector of the UE. For frequency range 2, DL PRS-RSRP may be measured based on the combined signal from antenna elements corresponding to a given receiver branch. For frequency range 1 and 2, if receiver diversity is in use by the UE, the reported DL PRS-RSRP value may not be lower than the corresponding DL PRS-RSRP of any of the individual receiver branches.

“DL PRS reference signal received path power (DL PRS-RSRPP),” is defined as the power of the linear average of the channel response at the i-th path delay of the resource elements that carry DL PRS signal configured for the measurement, where DL PRS-RSRPP for the 1st path delay is the power contribution corresponding to the first detected path in time. For frequency range 1, the reference point for the DL PRS-RSRPP may be the antenna connector of the UE. For frequency range 2, DL PRS-RSRPP may be measured based on the combined signal from antenna elements corresponding to a given receiver branch. For frequency range 1 and 2, if receiver diversity is in use by the UE for DL PRS-RSRPP measurements, the reported DL PRS-RSRPP value included in the higher layer parameter NR-DL-AoD-MeasElement for the first and additional measurements may be provided for the same receiver branch(es) as applied for DL PRS-RSRP measurements

“DL reference signal carrier phase (RSCP)” is defined as the phase of the channel response at the 1^{st} path delay derived from the resource elements carrying DL PRS configured for the measurement. DL RSCP is associated with the center frequency of the DL positioning frequency layer (PFL) configured for the measurement for RRC connected, RRC inactive, and RRC idle modes. For frequency range 1, the reference point for the DL RSCP may be the antenna connector of the UE. For frequency range 2, the reference point for the DL RSCP may be the antenna of the UE.

“DL reference signal carrier phase difference (RSCPD)” is defined as the difference of DL RSCPs measured from DL PRS transmitted in a DL PFL from the transmission point (TP)j and the reference TP i. If UE reports RSCPD measurements together with RSTD measurements in a measurement report element, the reference TP for RSCPD is the same as the reference TP reported for RSTD. For frequency range 1, the reference point for the DL RSCPD may be the antenna connector of the UE. For frequency range 2, the reference point for the DL RSCPD may be the antenna of the UE.

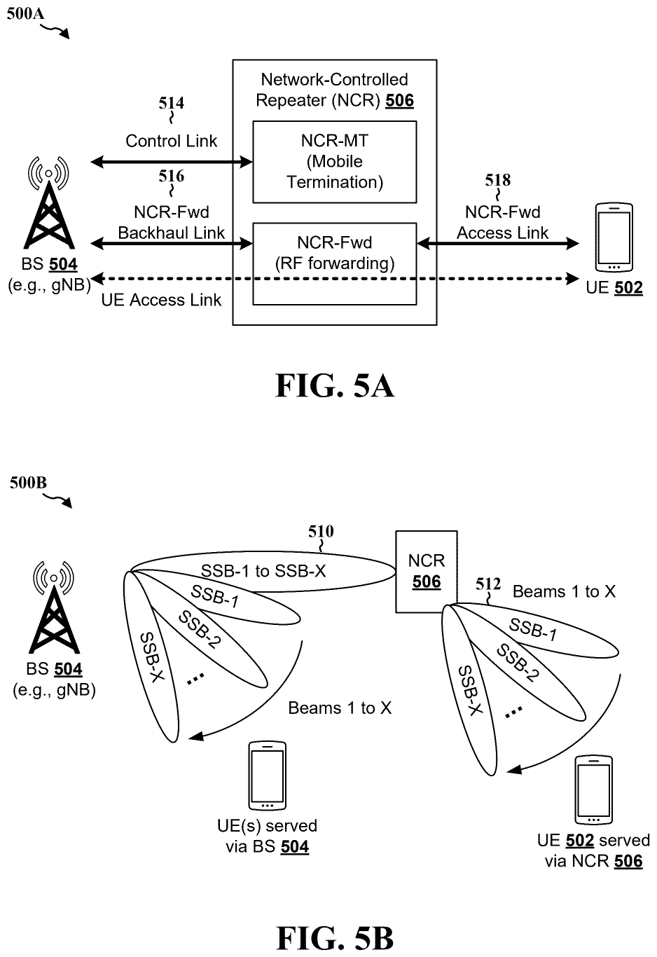

FIGS. 5A and 5B are diagrams 500A and 500B illustrating an example conceptual model of a network-controlled repeater (NCR) in accordance with various aspects of the present disclosure. A network-controlled repeater may refer to a device that is capable of extending the range and coverage of signals for telecommunications and networking. For example, as shown at 510 of FIG. 5B, an NCR 506 may be configured to receive a set of signals from a base station 504. Then, as shown at 512, the NCR 506 may transmit (e.g., forward, repeat, etc.) the set of signals to a UE 502, typically with a higher power and/or a different frequency that effectively amplify the set of signals to allow the set of signals to reach further distances and/or to penetrate obstacles better.

NCRs may be used in cellular networks, Wi-Fi systems, and other wireless communication technologies to ensure consistent coverage in areas where the original signal may be weak or degraded. NCRs may be remotely managed and configured, hence the “network-controlled” aspect, allowing network operators to optimize signal strength and performance without physical access to the device. For example, as shown at 514 of FIG. 5A, the base station 504 may control the NCR 506 via a control link. As shown at 516, the base station 504 may transmit the set of signals to the NCR 506 via an NCR forwarding backhaul link. Then, as shown at 518, the NCR 506 may transmit (e.g., forward, repeat, etc.) the set of signals to the UE 502 via an NCR forwarding access link. The control link from the base station 504 to the NCR 506 (e.g., to the NCR-mobile termination (NCR-MT)) may enable the base station 504 to configure various signal transmission (Tx) parameters (e.g., Tx power, beam direction, etc.) for both the backhaul link (e.g., between the base station 504 and the NCR 506) and the access link (e.g., between the NCR 506 and the UE 502).

In other words, NCR is a feature in wireless communication where a wireless device/repeater is configured to boost the signal from a network and transmit the boosted signal in the direction of a UE. Unlike a reconfigurable intelligent surface (RIS), which is typically designed to redirect the signal to an intended UE, an NCR may further amplify and transmit the signal in the intended beam towards the UE. In addition, unlike traditional/existing repeaters and/or relays, an NCR may include the capability to boost the signal at the analog level, thereby not amplifying the noise and also not causing higher latency. As such, the NCR may obtain better spatial directivity and simplify network integration.

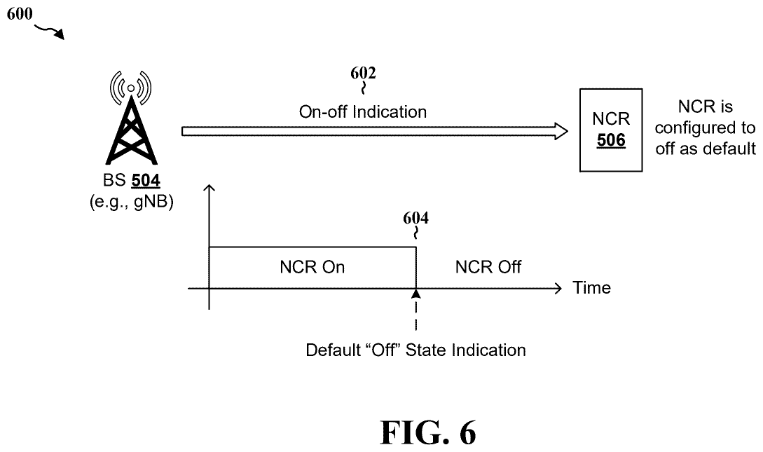

FIG. 6 is a diagram 600 illustrating an example of a base station activating and/or deactivating an NCR in accordance with various aspects of the present disclosure. An NCR may be activated/deactivated (i.e., switched on/off) by a base station (or a network entity) due to multiple reasons such as specifications, interference to the neighbors, power saving, etc. For example, as shown by the diagram 600, the NCR 506 may be configured to be deactivated (e.g., in an “off” state) by default. When the base station 504 demands the use of the NCR 506, as shown at 602, the base station 504 may transmit an indication to the NCR 506 to activate (i.e., switch on) the NCR 506. Then, as shown at 604, when the NCR 506 is active, the base station 504 may also send an indication to the NCR 506 to deactivate (i.e., switch off) the NCR 506, and/or the NCR 506 may be configured to switch to the deactivation/off state after a defined period of time or after being idle for a defined period of time, etc. When the NCR 506 is inactivated or not active, it may indicate that the NCR 506 is not being used presently in the communication, or it is being used for the communication but is temporarily disabled due to interference, power saving, etc.

Depending on implementations, an NCR itself may act/function as a UE. In other words, a UE may be configured to be an NCR. For example, when a UE has the capability to serve/function as an NCR, the UE may indicate such capability to a network entity (e.g., indicating to the serving base station/gNB that the UE is an NCR), such as via a radio resource control (RRC) setup complete (RRCSetupComplete) message. The network entity (e.g., the base station/gNB) may also be configured to indicate its support of NCR, such as through a flag in the system information block(s) (e.g., SIB1) broadcasted/transmitted by the network entity, such that an NCR may camp on cells that supports NCR. For purposes of differentiation, “NCR” described herein may refer to the entity that receives signal(s) from a network entity and transmits it to a UE, and “UE” may refer to the entity that receives the transmitted signal(s) from the NCR (note the UE may not be aware of the presence/use of the NCR).

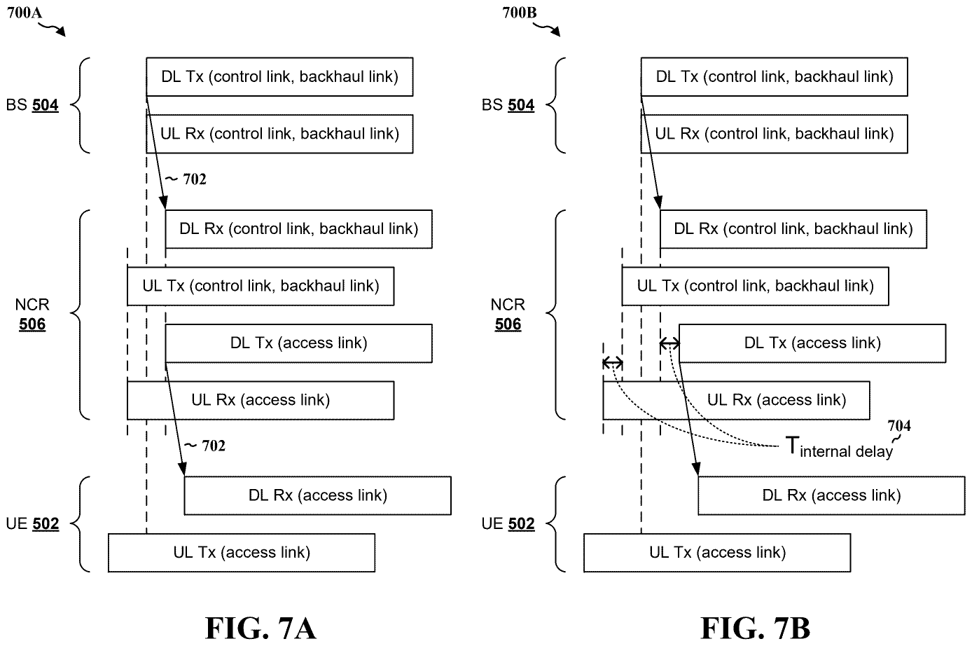

FIGS. 7A and 7B are diagrams 700A and 700B illustrating an example of signal timing delay due to NCR in accordance with various aspects of the present disclosure. As shown at 702 of FIG. 7A, when the base station 504 transmits a signal to the NCR 506 and the NCR 506 transmits the signal to the UE 502, it takes certain amount of time for the signal to be received by the UE 502. As shown at 704 of FIG. 7B, the NCR 506 may also cause a small delay due to amplifying the signal and/or forwarding the signal at analog level (which may be referred to as an “internal delay” of the NCR and denoted by T_{internal delay}).

With the assistance of the side control information, NCRs may perform the amplify-and-forward operations in a more efficient manner prompting them to be easily deployed and used for a great benefit. For example, it may be beneficial to deploy NCRs when there is no sufficient coverage or there are coverage gaps like rural, buildings, cellars, etc. In addition, NCRs may also be used to extend the applicability of the network-based positioning as described in connection with FIG. 4. For example, if a network entity (e.g., a base station) is unable to transmit reference signals (e.g., PRSs) directly to a UE and/or receive reference signals (e.g., SRSs) directly from the UE for positioning of the UE due to the range between the network entity and the UE, the network entity may try to deploy an NCR between the network entity and the UE to forward the reference signals. As such, the network entity and the UE may still achieve/perform the network-based positioning based on using the NCR. However, as discussed in connection with FIG. 7B, when a network-based positioning session includes using at least one NCR for positioning, the internal delay(s) of the at least one NCR may cause some inaccuracy in the positioning. Thus, network-based positioning (or other types of positioning) may demand additional considerations when NCR(s) are deployed for the positioning (e.g., when an NCR is in the path of a base station/TRP and a UE).

Aspects presented herein may improve the overall performance and accuracy of positioning that utilizes one or more NCRs, such as network-based positioning described in connection with FIG. 4. As NCRs may not be the same as the traditional/existing repeaters which just amplify the signals, aspects presented herein may enable delays associated with NCR(s) to be considered when NCR(s) are used for (assisting) positioning of a UE. For example, in one aspect of the present disclosure, when one or more NCRs are used by a base station for positioning of a UE, the location server (e.g., the location management function (LMF)) may be specified to be aware/notified of the presence of the NCR(s), and provide positioning configurations that are related to the NCR(s), such as providing configuration(s) for the NCR(s) and/or addressing delays related to the NCR(s) (e.g., taking the delay into consideration when estimating the location of the UE). In other words, as positioning configuration from an LMF may be configured with the presence of NCR, the LMF may be expected to be aware of the NCR.

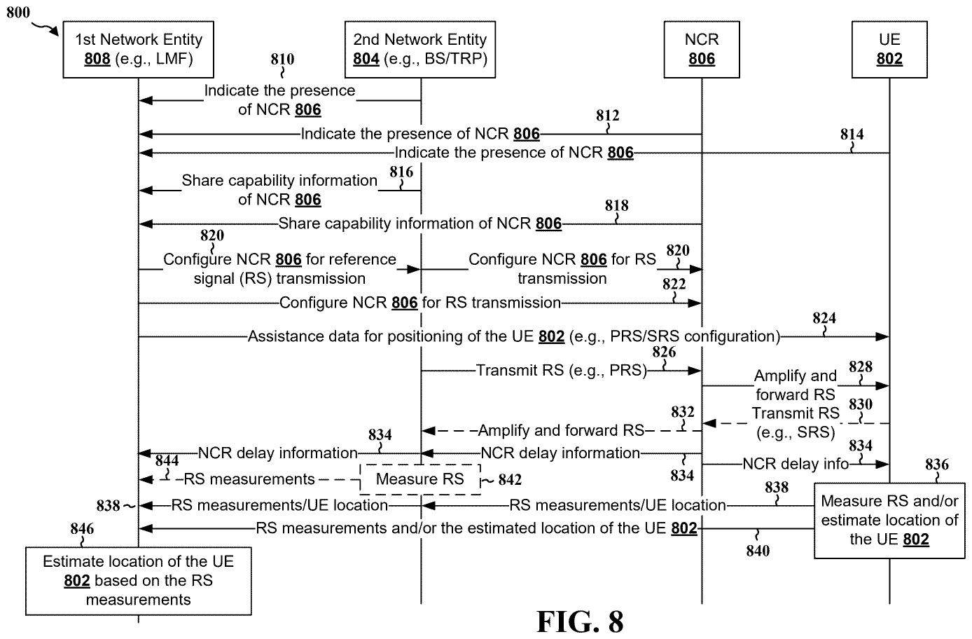

FIG. 8 is a communication flow 800 illustrating an example signaling for sharing NCR information between different entities for positioning in accordance with various aspects of the present disclosure. The numberings associated with the communication flow 800 do not specify a particular temporal order and are merely used as references for the communication flow 800. Aspects presented herein may enable sharing of the NCR information (e.g., by a base station/UE and/or the NCR itself) to a location server, such that the location server may configure/decide appropriate assistance data for positioning and compute the positioning more accurately. Aspects presented herein may also enable the location server to use the NCR to improve positioning especially by ensuring the geometric dilution of precision (GDOP).

In one aspect of the present disclosure, if a base station (e.g., a gNB) is using at least one NCR in the communication with a UE for a positioning session (e.g., a positioning session initiated by the base station), the base station may be configured/specified to indicate the use/presence of the at least one NCR to a location server (e.g., an LMF). Similarly, a UE may also be configured to indicate the use/presence of at least one NCR to the location server if the UE is aware of the use/presence of the at least one NCR (e.g., when a positioning session is initiated by the base station or the UE). However, in some scenarios, the UE may not be aware of the use/presence of the at least one NCR (even if the base station is using the at least one NCR).

For example, as shown at 810, after a positioning session is initiated for estimating the location of a UE 802, if a base station, a gNB, or a TRP, etc. (collectively as a “second network entity 804” hereafter) participating in the positioning session determines to use an NCR 806 for the positioning session, the second network entity 804 may transmit, to a first network entity 808 (e.g., a location server, an LMF, a sensing server, a sensing management function, etc.), an indication of the availability and/or the presence of the NCR 806. In some examples, as shown at 812, the NCR 806 may also indicate its presence to the first network entity 808 (if they are connected), and/or as shown at 814, the UE 802 may also indicate the presence of the NCR 806 to the first network entity 808 (if the UE 802 is aware of the presence/use of the NCR 806). In some examples, the positioning of the UE 802 may be initiated where the communication with UE 802 is already happening through the NCR 806. In such scenarios, the second network entity 804 may provide NCR information/details to the first network entity 808 and/or the UE 802 (e.g., to make adjustment to the positioning).

In some implementations, the second network entity 804, the NCR 806, and/or the UE 802 may also indicate, to the first network entity 808, the activation/deactivation (on/off) state of the NCR 806 (e.g., with the indication of the presence of the NCR 806 at 810, 812, and/or 814). The NCR 806 may be inactivated or not active if the NCR 506 is not being used presently in the communication, or it is being used for the communication but is temporarily disabled due to interference, power saving, etc. For example, at 810, the second network entity 804 may transmit, to the first network entity 808, an indication that the NCR 806 is used (or going to be used) for the positioning of the UE 802, and that the NCR 806 is currently activated (on) or deactivated (off). The second network entity 804, the NCR 806, and/or the UE 802 may be configured to indicate the activation/deactivation (on/off) state of the NCR 806 when the NCR 806 is causing interference, especially in special slots of the time division duplex (TDD). As such, the first network entity 808 may determine whether to deactivate (switch off) the NCR 806 to avoid interference with one or more neighbor cells if the NCR 806 is currently activated (switched on). In some examples, the first network entity 808 may be able to obtain the TDD configuration (e.g., shared by the second network entity 804 if available), and the first network entity 808 may be configured to refrain from (e.g., avoid) configuring reference signals (e.g., PRS) in those special slots. In some examples, other periodic resources during which the NCR 806 is deemed to be deactivated (off) may also be indicated to the first network entity for the same or similar purpose.

In another aspect of the present disclosure, a radio access network (RAN) may be configured to indicate the presence of the NCR(s) in a region along with their known location(s). For example, when the second network entity 804, the NCR 806, and/or the UE 802 indicates the presence of the NCR 806 to the first network entity 808, the indication may also include the location (e.g., the geographical location such as the coordinates) of the NCR 806 if the location of the NCR is known by the second network entity 804, the NCR 806, and/or the UE 802. In other words, the first network entity 808 may be specified to know the location of the NCR 806 prior to using the NCR 806 for positioning or prior to providing configurations related to using the NCR 806 for positioning.

In some implementations, if the location(s) of the NCR(s) are unknown, a location server (e.g., the first network entity 808, an LMF, etc.) may be configured to initiate a positioning session for the NCR(s) with unknown location(s) (i.e., for determining the location(s) of the NCR(s)). For example, if the location of the NCR 806 is unknown, the first network entity 808 may request the second network entity 804 to amplify and forward a set of reference signals (RSs) (e.g., a set of PRSs) using a transmitting beam that is the same (e.g., in the same direction) as the receiving beam that receives the set of RSs, such that the second network entity 804 may estimate the location of the NCR 806 using the set of RSs forwarded from the NCR 806. This process may be done by multiple base stations as well for validation if the NCR 806 is under the purview of multiple base stations. In some examples, as NCRs may be UEs with positioning capability (e.g., GNSS positioning capability), the NCRs may also determine their locations using their positioning capability, and report their locations (e.g., to the first network entity 808, the second network entity 804, and/or the UE 802, etc.).

In some implementations, when multiple NCRs are available for positioning, the first network entity 808 (e.g., an LMF) may request the second network entity 804 (e.g., a base station/gNB) to enable and configure a set of available NCRs (in the multiple NCRs) to transmit/forward a set of RSs (e.g., to the second network entity 804 or towards a specific direction, etc.). Based on measurements obtained from the set of RSs transmitted by the set of available NCRs (e.g., measurements obtained by the second network entity 804 or another network entities that are capable of receiving and measuring the set of RSs), the first network entity 808 may determine/select which NCR(s) to use for the positioning of the UE 802, such as NCR(s) that are able to provide better GDOP based on their locations, or NCR(s) with better signal strength (e.g., in line-of-sight (LOS) with the second network entity 804 and/or the UE 802), etc.

Similarly, in some implementations, the UE 802 may be configured (e.g., by the first network entity 808 and/or the second network entity 804) to measure multiple PRS instances (e.g., multiple sets of PRSs) from the second network entity 804 (i.e., from the same base station/gNB), where each PRS instance (each set of PRSs) is amplified and forwarded/transmitted from a different NCR. For example, the UE 802 may be configured to measure three sets of PRSs from the second network entity 804, there the three sets of PRSs are amplified and forwarded/transmitted from three different NCRs. The UE 802 may not be specified to know that the three sets of PRSs are from three different NCRs (e.g., such configuration/setting may be transparent to the UE 802). Then, the UE 802 may provide measurements related to the three sets of PRSs to the first network entity 808 and/or the second network entity 804. Such configuration may assist/help the first network entity 808 and/or the second network entity 804 to obtain multiple measurements for a better positioning especially in areas where there may not be enough base stations or when NCR(s) are used to ensure/provide better GDOP. This may be configured and repeated for other base station(s) in the area as well.

In another aspect of the present disclosure, the base station/NCR may also be configured to provide capability information of the NCR to the location server. For example, as shown at 816 and 818, the second network entity 804 and/or the NCR 806 may provide the capability information of the NCR 806 to the first network entity 808, such as the number of beams and/or the maximum transmission/amplification power supported by the NCR 806, etc. In other words, a base station may report, to the location server, the capability information of each NCR it uses, such as the number of beams or transmission/amplification power supported by each NCR, since their capability (e.g., beam capability) may be different from each other. Note while the communication flow 800 shows the capability information of the NCR 806 is transmitted via a separated message (e.g., at 816/818) from the indication message (e.g., at 810/812/814), it is merely for illustration purposes. Depending on implementations, the second network entity 804, the NCR 806, and/or the UE 802 may also provide the capability information of the NCR 806 along with the indication of the presence of NCR 806.

The capability information of the NCR 806 may be used by the first network entity 808 for configuring the NCR 806 (discussed below), the positioning session, and/or for NCR selection. For example, the capability information of multiple NCRs may enable the first network entity 808 (e.g., the LMF) to decide/select NCR(s) to be used for the positioning of the UE 802 and/or decide/select parameters for the NCR(s) to be used for the positioning of the UE 802 (e.g., to use NCR(s) with more beams, with narrower beams, with higher/further transmission (Tx) power/range, etc.) to improve the positioning performance and/or accuracy.

Based on the indication of the presence of the NCR 806 (e.g., as discussed in connection with 810/812/814), the location of the NCR 806, and/or the capability information of the NCR 806 (e.g., as discussed in connection with 816/818), the first network entity 808 may configure the NCR 806 for RS transmission (e.g., for RS forwarding and amplification). For example, the configuration of the NCR 806 may include determining whether to select/use the NCR 806 (and also other NCR(s)) for the positioning of the UE 802 (assuming the NCR 806 is selected/used here for purposes of illustration), the (Tx/amplification) power to be used by the NCR 806, the beam(s) to be used by the NCR 806, and/or the width of beam(s) to be used by the NCR 806, etc. Then, as shown at 820, the first network entity 808 may transmit the configuration for the NCR 806 (referring to as the “NCR configuration” hereafter”) to the second network entity 804, and then the second network entity 804 may transmit/forward the NCR configuration to the NCR 806. Alternatively, as shown at 822, the first network entity 808 may also transmit the NCR configuration directly to the NCR 806 if supported.

At 824, the first network entity 808 may transmit, to the UE 802, assistance data (AD) related to the positioning of the UE 802. For example, the AD may indicate the resources to be used by the second network entity 804 for transmitting reference signals (e.g., PRSs) to the UE 802 for the positioning, and/or the resources to be used by the UE 802 for transmitting reference signals (e.g., SRSs) to the second network entity 804 for the positioning, such as described in connection with FIG. 4.

At 826, the second network entity 804 may be configured to transmit a set of RSs (e.g., a set of PRSs) to the NCR 806 for the positioning session of the UE 802. At 828, after the NCR 806 receives the set of RSs, the NCR 806 may amplify and transmit/forward the set of RSs to the UE 802 (e.g., based on the NCR configuration received at 820/822). If the UE 802 is configured to transmit a set of RSs to the network entity 804 (e.g., a set of SRSs) or towards the NCR 806 (as the UE 802 may not be aware of the presence of the NCR 806), at 830, the UE 802 may transmit a set of RSs towards the NCR 806. Similarly, at 832, after the NCR 806 receives the set of RSs, the NCR 806 may amplify and transmit/forward the set of RSs to the second network entity 804 (e.g., based on the NCR configuration received at 820/822).

At 834, after amplifying and transmitting/forwarding the set of RSs (e.g., the set of PRSs and/or the set of SRSs), the NCR 806 may provide delay associated with amplifying and/or transmitting/forwarding the set of RSs (which may be referred to as the “delay information” or the “NCR delay information” hereafter) to the first network entity 808, the second network entity 804, and/or the UE 802, etc. (e.g., depending on which entity is configured to estimate the location of the UE 802). For example, depending on implementations, the NCR 806 may transmit the NCR delay information to the UE 802 if the UE 802 is configured to estimate its own location and is aware of the presence of the NCR 806, or transmit the NCR delay information to the first network entity 808 directly (if supported) or indirectly via the second network entity 804 if the first network entity 808 is configured to estimate the location of the UE 802. In some examples, the NCR delay information may be a transmission time at which the set of RSs is transmitted/forwarded from the NCR 806.

In other words, the delay at the NCR 806 is configured to be reported to the first network entity 808 (e.g., the LMF). This delay may be from the time of the reception of the set of RSs to the time of transmission/forwarding of the set of RSs (including processing and amplifying the set of RSs). For example, the delay associated with receiving and forwarding a set of PRSs from the second network entity 804 may be from the time of reception of PRS on the backhaul link to the time of transmission on the access link as discussed in connection with FIGS. 7A and 7B. The NCR 806 may report this delay (i.e., the NCR delay information) directly to the first network entity 808 or the NCR 806 may report the delay to the second network entity 804 and the second network entity 804 may report the delay to the first network entity 808. Since NCR 806 may act as a UE itself for the control link (connection establishment, security, etc.) in some implementations, the NCR 806 may have a direct communication with the first network entity 808 to share this delay information.

As an alternative (or in addition to), the NCR 806 may also share/provide the RS transmission time (e.g., the time the set of RSs is transmitted by the NCR 806) instead of the delay information. For example, the NCR may share/provide the PRS/SRS transmit time information to the first network entity 808, the second network entity 804, and/or the UE 802. Then, the first network entity 808, the second network entity 804, and/or the UE 802 may derive/obtain the NCR delay information based on the PRS/SRS transmit time information. Though the delay may be small, it may still cause error in positioning computation and thus it will be beneficial to take this delay into consideration. In some implementations, if the positioning of the UE 802 is based on AoD, the NCR 806 may also be configured to provide its AoD that is specified for the positioning.

At 836, based on the AD (e.g., received at 824), the UE 802 may receive and measure the set of RSs (e.g., a set of PRSs) transmitted from the NCR 806 at 828 to obtain a set of RS measurements (referring to as the “PRS measurements” for purposes of differentiation). As discussed above, depending on implementations, the UE 802 may not be aware of the presence/use of the NCR 806. Also, depending on the type of positioning configured for the positioning session, the UE 802 may also be configured to estimate its location based on the PRS measurements, such as described in connection with FIG. 4. If the UE 802 is configured to estimate its location based on the PRS measurements, the UE 802 may be specified to take the delay information of the NCR 806 (e.g., received at 834) (or the transmission time of the set of RSs) into account.

After obtaining the PRS measurements and/or the location of the UE 802 (e.g., at 836), the UE 802 may provide the PRS measurements and/or the location of the UE 802 to the first network entity 808. For example, as shown at 838, the UE 802 may transmit the PRS measurements and/or the estimated location of the UE 802 to the second network entity 804, and the second network entity 804 may forward/transmit the PRS measurements and/or the estimated location of the UE 802 to the first network entity 808. As shown at 840, the UE 802 may also transmit the PRS measurements and/or the estimated location of the UE 802 directly to the first network entity 808.

Similarly, as shown at 842, if the UE 802 is configured to transmit a set of RSs (e.g., a set of SRSs) to the second network entity 804, the second network entity 804 may receive and measure the set of RSs transmitted/forwarded from the NCR 806 at 832 to obtain a set of RS measurements (referring to as the “SRS measurements” for purposes of differentiation). Then, at 844, the second network entity 804 may transmit the SRS measurements to the first network entity 808.

Note while the communication flow shows the NCR delay information (e.g., transmitted at 834) and the PRS/SRS measurements (e.g., transmitted at 838/840/844) are transmitted via different messages, it is merely for illustration purposes. Depending on implementations, the UE 802 and/or the second network entity 804 may also be configured to provide the PRS/SRS measurements along with the delay information of the NCR 806 to the first network entity 808 via the same message. For example, at 840, the UE 802 may transmit the PRS measurements and the delay information of the NCR 806 to the first network entity 808. Similarly, at 844, the second network entity may transmit the SRS measurements and the delay information of the NCR 806 to the first network entity 808.

At 846, if the first network entity 808 is configured to (or responsible for) estimating the location of the UE 802, the first network entity 808 may estimate the location of the UE 802 based the PRS measurements received from the UE 802 and/or the SRS measurements received from the second network entity 804, and also based on the delay information of the NCR 806 (and also based on other parameters applied by the NCR 806 related to positioning, such as the AoD).

In some implementations, the first network entity 808 may also instruct the second network entity 804 to configure the NCR 806 to transmit the set of RSs on different beams. For example, at 820, the first network entity 808 may request the second network entity 804 to configure the NCR 806 to transmit a set of PRSs to the UE 802 using three different beams (e.g., beams with different widths, directions, etc.). Such configuration may enable the first network entity 808 to have multiple measurements of the set of RSs on different beams especially in the scenarios where the NCR 806 is using narrow/narrower beams and this may help improving the positioning accuracy. The instruction/request may include the beam to be used along with the resources (e.g., time/frequency resources of the set of RSs) to be transmitted on that beam. In some examples, the first network entity 808 may also instruct/request the second network entity 804 to configure the NCR 806 to amplify the RS transmission power so that if the UE 802 is outside the cell edge and is also far away from the NCR 806, the UE 802 may still be able to receive the set of RSs with proper power.

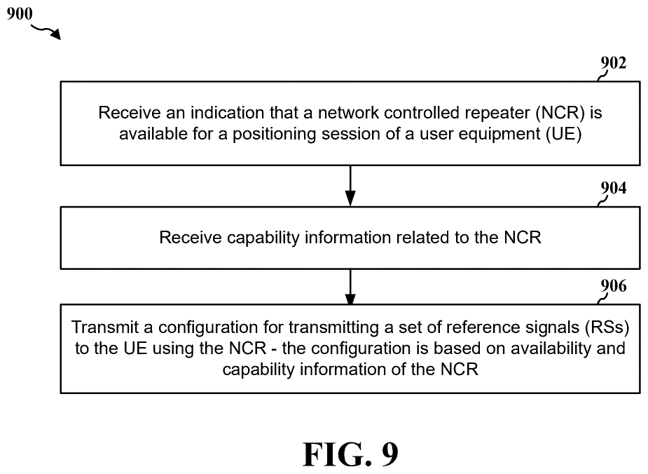

FIG. 9 is a flowchart 900 of wireless communication. The method may be performed by a first network entity (e.g., the one or more location servers 168; the first network entity 808; the network entity 1060). The method may enable the first network entity to provide configurations related to NCR(s), thereby improving the overall performance and accuracy of network-based positioning that utilizes one or more NCRs.

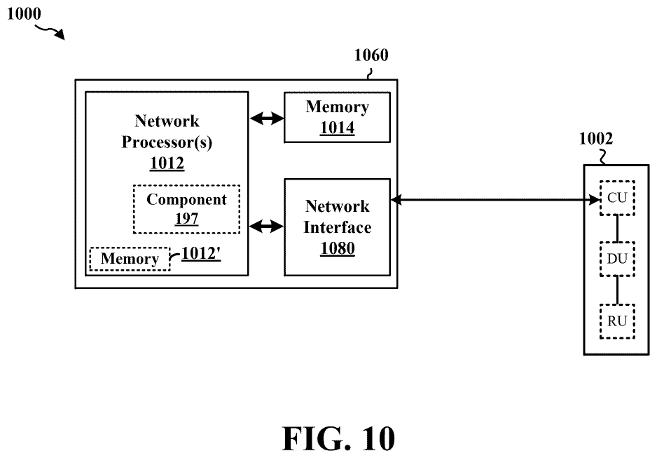

At 902, the first network entity may receive an indication that an NCR is available for a positioning session of a UE, such as described in connection with FIG. 8. For example, at 810, after a positioning session is initiated for estimating the location of a UE 802, if a base station, a gNB, or a TRP, etc. (collectively as a “second network entity 804” hereafter) participating in the positioning session determines to use an NCR 806 for the positioning session, the second network entity 804 may transmit, to a first network entity 808 (e.g., a location server, an LMF, a sensing server, a sensing management function, etc.), an indication of the presence of the NCR 806. In some examples, as shown at 812, the NCR 806 may indicate its presence to the first network entity 808 (if they are connected), and/or as shown at 814, the UE 802 may indicate the presence of the NCR 806 to the first network entity 808 (if the UE 802 is aware of the presence/use of the NCR 806). The reception of the indication may be performed by, e.g., the NCR configuration component 197, the network processor(s) 1012, and/or the network interface 1080 of the network entity 1060 in FIG. 10.

At 904, the first network entity may receive capability information related to the NCR, such as described in connection with FIG. 8. For example, at 816 and 818, the second network entity 804 and/or the NCR 806 may provide the capability information of the NCR 806 to the first network entity 808, such as the number of beams and/or the maximum transmission/amplification power supported by the NCR 806, etc. The reception of the capability information related to the NCR may be performed by, e.g., the NCR configuration component 197, the network processor(s) 1012, and/or the network interface 1080 of the network entity 1060 in FIG. 10.

At 906, the first network entity may transmit a configuration for transmitting a set of RSs to the UE using the NCR, where the configuration is based on availability and capability information of the NCR, such as described in connection with FIG. 8. For example, based on the indication of the presence of the NCR 806 (e.g., as discussed in connection with 810/812/814), the location of the NCR 806, and/or the capability information of the NCR 806 (e.g., as discussed in connection with 816/818), the first network entity 808 may configure the NCR 806 for RS transmission (e.g., for RS forwarding and amplification). For example, the configuration of the NCR 806 may include determining whether to select/use the NCR 806 (and also other NCR(s)) for the positioning of the UE 802 (assuming the NCR 806 is selected/used for purposes of illustration), the (Tx/amplification) power to be used by the NCR 806, the beam(s) to be used by the NCR 806, and/or the width of beam(s) to be used by the NCR 806, etc. Then, as shown at 820, the first network entity 808 may transmit the configuration for the NCR 806 (referring to as the “NCR configuration” hereafter”) to the second network entity 804, and then the second network entity 804 may transmit/forward the NCR configuration to the NCR 806. Alternatively, as shown at 822, the first network entity 808 may also transmit the NCR configuration directly to the NCR 806 if supported. The transmission of the configuration may be performed by, e.g., the NCR configuration component 197, the network processor(s) 1012, and/or the network interface 1080 of the network entity 1060 in FIG. 10.

In one example, the first network entity may further receive a second indication of whether the NCR is activated, inactivated, or not active, and transmit a request to activate the NCR if the NCR is inactivated or not active. In some implementations, the indication further includes a location of the NCR, and where the request to activate the NCR is further based on the location of the NCR.

In another example, the first network entity may further initiate a position session for identifying a location of the NCR if the location of the NCR is unknown, and obtain the location of the NCR based on the positioning session, where transmission of the configuration is based on the location of the NCR being known.

In another example, the first network entity may further transmit, to a second network entity, a request to configure the NCR to amplify and forward the set of RSs. In some implementations, the request further instructs the second network entity to configure the NCR to amplify and forward the set of RSs using a same beam that is used for receiving the set of RSs by the NCR.

In another example, the first network entity may further transmit, to the UE, assistance data for receiving the set of RSs from multiple NCRs including the NCR, and receiving, from the UE based on the assistance data, a set of measurements for the set of RSs. In some implementations, the first network entity may receive, from a second network entity or the NCR, at least one of delay information associated with the NCR or a transmission time for transmitting the set of RSs from the NCR, and estimate a position of the UE based on the set of measurements and at least one of the delay information or the transmission time. In some implementations, the first network entity may receive, from a second network entity or the NCR, an AoD for transmitting the set of RSs by the NCR, and estimate a position of the UE based on the set of measurements and the AoD.

In another example, the capability information of the NCR includes at least a number of beams or a maximum transmission power supported by the NCR. In some implementations, the first network entity may transmit, to a second network entity, a request to configure the NCR to transmit the set of RSs on different beams.

In another example, to receive the indication, the first network entity may be configured to receive the indication from a second network entity or the UE.

In another example, to receive the capability information related to the NCR, the first network entity may be configured to receive the capability information related to the NCR from a second network entity.

In another example, to transmit the configuration, the first network entity may be configured to transmit the configuration to a second network entity or the NCR.

FIG. 10 is a diagram 1000 illustrating an example of a hardware implementation for a network entity 1060. In one example, the network entity 1060 may be within the core network 120. The network entity 1060 may include at least one network processor 1012. The network processor(s) 1012 may include on-chip memory 1012′. In some aspects, the network entity 1060 may further include additional memory modules 1014. The network entity 1060 communicates via the network interface 1080 directly (e.g., backhaul link) or indirectly (e.g., through a RIC) with the CU 1002. The on-chip memory 1012′ and the additional memory modules 1014 may each be considered a computer-readable medium/memory. Each computer-readable medium/memory may be non-transitory. The network processor(s) 1012 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the NCR configuration component 197 may be configured to receive an indication that an NCR is available for a positioning session of a UE. The NCR configuration component 197 may also be configured to receive capability information related to the NCR. The NCR configuration component 197 may also be configured to transmit a configuration for transmitting a set of RSs to the UE using the NCR, where the configuration is based on availability and capability information of the NCR. The NCR configuration component 197 may be within the network processor(s) 1012. The NCR configuration component 197 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1060 may include a variety of components configured for various functions. In one configuration, the network entity 1060 may include means for receiving an indication that an NCR is available for a positioning session of a UE. The network entity 1060 may further include means for receiving capability information related to the NCR. The network entity 1060 may further include means for transmitting a configuration for transmitting a set of RSs to the UE using the NCR, where the configuration is based on availability and capability information of the NCR.

In one configuration, the network entity 1060 may further include means for receiving a second indication of whether the NCR is activated, inactivated, or not active, and means for transmitting a request to activate the NCR if the NCR is inactivated or not active. In some implementations, the indication further includes a location of the NCR, and where the request to activate the NCR is further based on the location of the NCR.

In another configuration, the network entity 1060 may further include means for initiating a position session for identifying a location of the NCR if the location of the NCR is unknown, and means for obtaining the location of the NCR based on the positioning session, where transmission of the configuration is based on the location of the NCR being known.

In another configuration, the network entity 1060 may further include means for transmitting, to a second network entity, a request to configure the NCR to amplify and forward the set of RSs. In some implementations, the request further instructs the second network entity to configure the NCR to amplify and forward the set of RSs using a same beam that is used for receiving the set of RSs by the NCR.

In another configuration, the network entity 1060 may further include means for transmitting, to the UE, assistance data for receiving the set of RSs from multiple NCRs including the NCR, and means for receiving, from the UE based on the assistance data, a set of measurements for the set of RSs. In some implementations, the network entity 1060 may further include means for receiving, from a second network entity or the NCR, at least one of delay information associated with the NCR or a transmission time for transmitting the set of RSs from the NCR, and means for estimating a position of the UE based on the set of measurements and at least one of the delay information or the transmission time. In some implementations, the network entity 1060 may further include means for receiving, from a second network entity or the NCR, an AoD for transmitting the set of RSs by the NCR, and estimate a position of the UE based on the set of measurements and the AoD.

In another configuration, the capability information of the NCR includes at least a number of beams or a maximum transmission power supported by the NCR. In some implementations, the network entity 1060 may further include means for transmitting, to a second network entity, a request to configure the NCR to transmit the set of RSs on different beams.

In another configuration, the means for receiving the indication may include configuring the network entity 1060 to receive the indication from a second network entity or the UE.

In another configuration, the means for receiving the capability information related to the NCR may include configuring the network entity 1060 to receive the capability information related to the NCR from a second network entity.

In another configuration, the means for transmitting the configuration may include configuring the network entity 1060 to transmit the configuration to a second network entity or the NCR.

The means may be the NCR configuration component 197 of the network entity 1060 configured to perform the functions recited by the means.

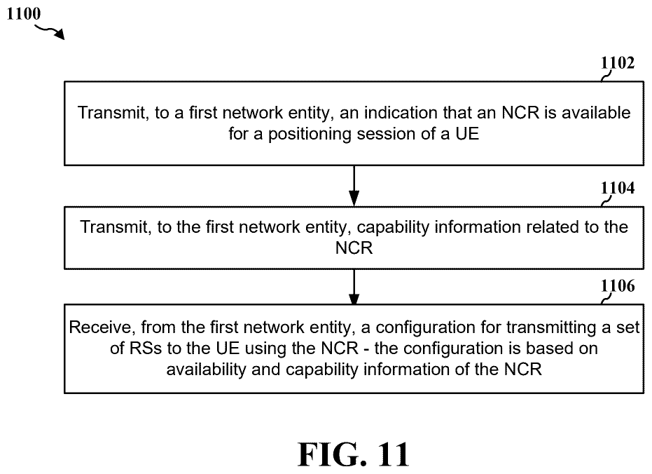

FIG. 11 is a flowchart 1100 of wireless communication. The method may be performed by a second network entity (e.g., the base station 102, 504; the second network entity 804; the network entity 1202). The method may enable the second network entity to inform the first network entity regarding the presence of NCR(s) to enable the first network entity to provide configurations related to NCR(s), thereby improving the overall performance and accuracy of network-based positioning that utilizes one or more NCRs.

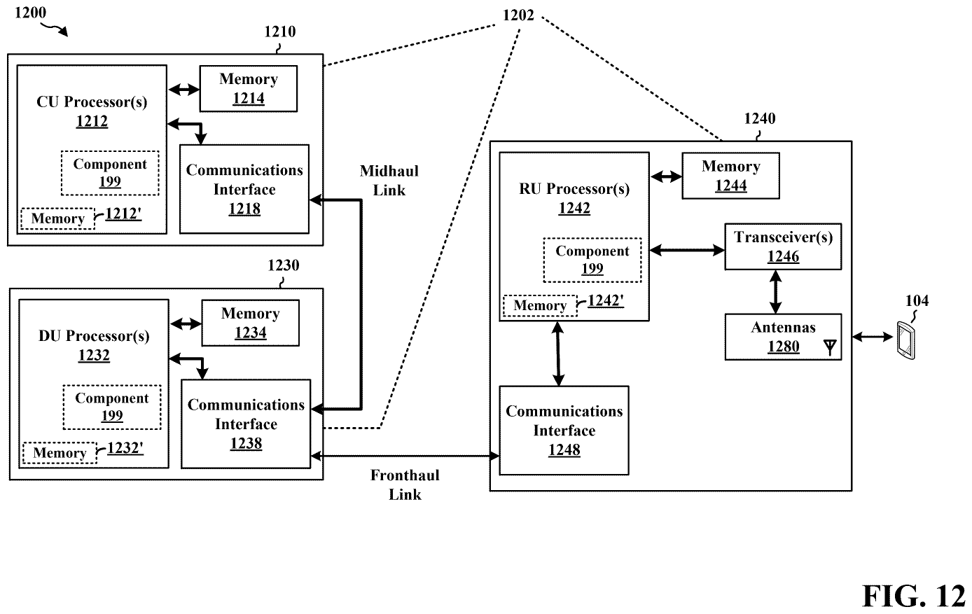

At 1102, the second network entity may transmit, to a first network entity, an indication that an NCR is available for a positioning session of a UE, such as described in connection with FIG. 8. For example, at 810, after a positioning session is initiated for estimating the location of a UE 802, if a base station, a gNB, or a TRP, etc. (collectively as a “second network entity 804” hereafter) participating in the positioning session determines to use an NCR 806 for the positioning session, the second network entity 804 may transmit, to a first network entity 808 (e.g., a location server, an LMF, a sensing server, a sensing management function, etc.), an indication of the presence of the NCR 806. The transmission of the indication may be performed by, e.g., the NCR control component 199, the transceiver(s) 1246, the RU processor(s) 1242, the DU processor(s) 1232, and/or the CU processor(s) 1212, of the network entity 1202 in FIG. 12.

At 1104, the second network entity may transmit, to the first network entity, capability information related to the NCR, such as described in connection with FIG. 8. For example, at 816, the second network entity 804 may provide the capability information of the NCR 806 to the first network entity 808, such as the number of beams and/or the maximum transmission/amplification power supported by the NCR 806, etc. The transmission of the capability information related to the NCR may be performed by, e.g., the NCR control component 199, the transceiver(s) 1246, the RU processor(s) 1242, the DU processor(s) 1232, and/or the CU processor(s) 1212, of the network entity 1202 in FIG. 12.

At 1106, the second network entity may receive, from the first network entity, a configuration for transmitting a set of RSs to the UE using the NCR, where the configuration is based on availability and capability information of the NCR, such as described in connection with FIG. 8. For example, as shown at 820, the second network entity 804 may receive, from the first network entity 808, the configuration for the NCR 806 (referring to as the “NCR configuration”), and then the second network entity 804 may transmit/forward the NCR configuration to the NCR 806. The reception of the configuration may be performed by, e.g., the NCR control component 199, the transceiver(s) 1246, the RU processor(s) 1242, the DU processor(s) 1232, and/or the CU processor(s) 1212, of the network entity 1202 in FIG. 12.

In one example, the second network entity may further transmit, based on the configuration, the set of RSs to the NCR.

In another example, the second network entity may further transmit the configuration to the NCR based on reception of the NCR from the first network entity.

In another example, the second network entity may further transmit, to the first network entity, a second indication of whether the NCR is activated, inactivated, or not active, and receive, from the first network entity, a request to activate the NCR if the NCR is inactivated or not active. In some implementations, the indication further includes a location of the NCR, and where the request to activate the NCR is further based on the location of the NCR.

In another example, the second network entity may further receive, from the first network entity, a request to configure the NCR to amplify and forward the set of RSs, and transmit, to the NCR based on the request, a second indication to amplify and forward the set of RSs. In some implementations, the request further instructs the second network entity to configure the NCR to amplify and forward the set of RSs using a same beam that is used for receiving the set of RSs by the NCR.

In another example, the second network entity may further receive, from the NCR, at least one of delay information associated with the NCR or an AoD for transmitting the set of RSs by the NCR, and transmit, to the first network entity, the delay information or the AoD.

In another example, the capability information of the NCR includes at least a number of beams or a maximum transmission power supported by the NCR. In some implementations, the second network entity may further receive, from the first network entity, a request to configure the NCR to transmit the set of RSs on different beams, and transmit, to the NCR based on the request, a second indication to transmit the set of RSs on the different beams.

In another example, the second network entity is a base station, and the first network entity is an LMF, an NWDAF, or a sensing management function.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the NCR control component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the NCR control component 199 may be configured to transmit, to a first network entity, an indication that an NCR is available for a positioning session of a UE. The NCR control component 199 may also be configured to transmit, to the first network entity, capability information related to the NCR. The NCR control component 199 may also be configured to receive, from the first network entity, a configuration for transmitting a set of RSs to the UE using the NCR, where the configuration is based on availability and capability information of the NCR. The NCR control component 199 may be within one or more processors of one or more of the CU 1210, DU 1230, and the RU 1240. The NCR control component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for transmitting, to a first network entity, an indication that an NCR is available for a positioning session of a UE. The network entity 1202 may further include means for transmitting, to the first network entity, capability information related to the NCR. The network entity 1202 may further include means for receiving, from the first network entity, a configuration for transmitting a set of RSs to the UE using the NCR, where the configuration is based on availability and capability information of the NCR.

In one configuration, the network entity 1202 may further include means for transmitting, based on the configuration, the set of RSs to the NCR.

In another configuration, the network entity 1202 may further include means for transmitting the configuration to the NCR based on reception of the NCR from the first network entity.

In another configuration, the network entity 1202 may further include means for transmitting, to the first network entity, a second indication of whether the NCR is activated, inactivated, or not active, and means for receiving, from the first network entity, a request to activate the NCR if the NCR is inactivated or not active. In some implementations, the indication further includes a location of the NCR, and where the request to activate the NCR is further based on the location of the NCR.

In another configuration, the network entity 1202 may further include means for receiving, from the first network entity, a request to configure the NCR to amplify and forward the set of RSs, and means for transmitting, to the NCR based on the request, a second indication to amplify and forward the set of RSs. In some implementations, the request further instructs the second network entity to configure the NCR to amplify and forward the set of RSs using a same beam that is used for receiving the set of RSs by the NCR.

In another configuration, the network entity 1202 may further include means for receiving, from the NCR, at least one of delay information associated with the NCR or an AoD for transmitting the set of RSs by the NCR, and means for transmitting, to the first network entity, the delay information or the AoD.

In another configuration, the capability information of the NCR includes at least a number of beams or a maximum transmission power supported by the NCR. In some implementations, the network entity 1202 may further include means for receiving, from the first network entity, a request to configure the NCR to transmit the set of RSs on different beams, and means for transmitting, to the NCR based on the request, a second indication to transmit the set of RSs on the different beams.

In another configuration, the second network entity is a base station, and the first network entity is an LMF, an NWDAF, or a sensing management function.

The means may be the NCR control component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

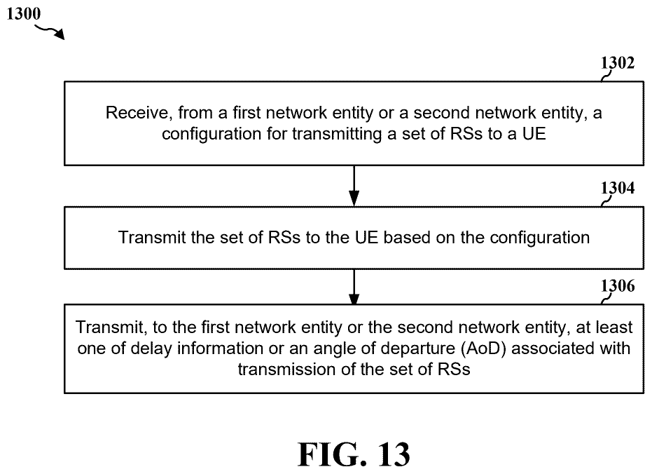

FIG. 13 is a flowchart 1300 of wireless communication. The method may be performed by an NCR (e.g., the UE 104 (e.g., when operating as an NCR); the NCR 506, 806; the apparatus 1404). The method may enable the NCR to transmit/forward reference signals for positioning of a UE and provide the delay information related to transmitting/forwarding the reference signals, thereby promoting consistency for AI//ML positioning/sensing operation(s) at different entities.

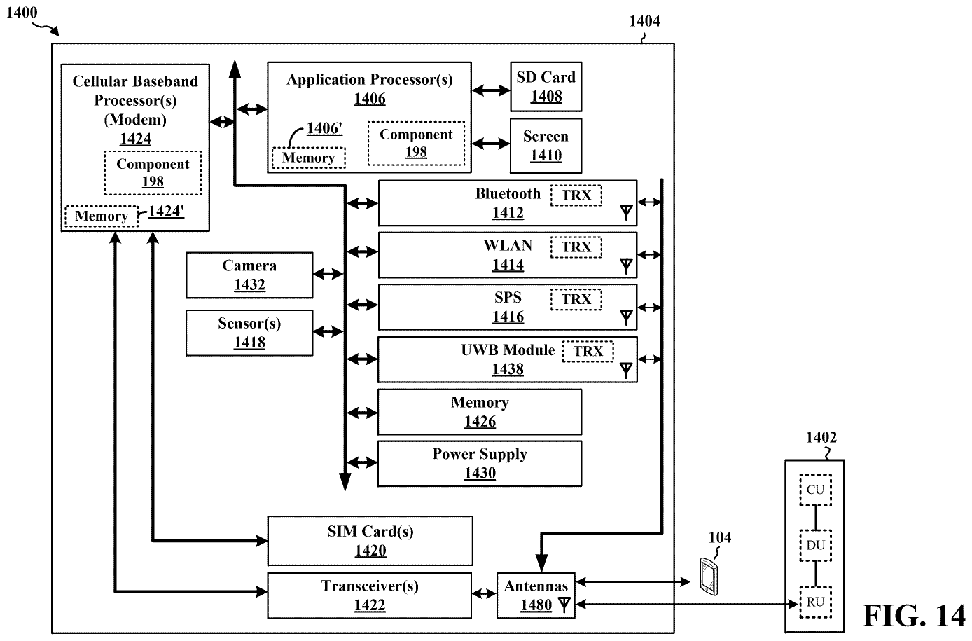

At 1302, the NCR may receive, from a first network entity or a second network entity, a configuration for transmitting a set of RSs to a UE, such as described in connection with FIG. 13. For example, at 820, the first network entity 808 may transmit the configuration for the NCR 806 (referring to as the “NCR configuration” hereafter”) to the second network entity 804, and then the NCR 806 may receive the NCR configuration from the second network entity 804. Alternatively, as shown at 822, the NCR 806 may receive, from the first network entity 808, the NCR configuration directly if supported. The reception of the configuration may be performed by, e.g., the NCR component 198, the transceiver(s) 1422, the cellular baseband processor(s) 1424, and/or the application processor(s) 1406 of the apparatus 1404 in FIG. 14.

At 1304, the NCR may transmit the set of RSs to the UE based on the configuration, such as described in connection with FIG. 13. For example, at 828, after the NCR 806 receives the set of RSs, the NCR 806 may amplify and transmit/forward the set of RSs to the UE 802 (e.g., based on the NCR configuration received at 820/822). Similarly, at 832, after the NCR 806 receives the set of RSs, the NCR 806 may amplify and transmit/forward the set of RSs to the second network entity 804 (e.g., based on the NCR configuration received at 820/822). The transmission of the set of RSs may be performed by, e.g., the NCR component 198, the transceiver(s) 1422, the cellular baseband processor(s) 1424, and/or the application processor(s) 1406 of the apparatus 1404 in FIG. 14.

At 1306, the NCR may transmit, to the first network entity or the second network entity, at least one of delay information or an AoD associated with transmission of the set of RSs, such as described in connection with FIG. 13. For example, at 834, after amplifying and transmitting/forwarding the set of RSs (e.g., the set of PRSs and/or the set of SRSs), the NCR 806 may provide delay associated with amplifying and/or transmitting/forwarding the set of RSs (which may be referred to as the “delay information” or the “NCR delay information” hereafter) to the first network entity 808, the second network entity 804, and/or the UE 802, etc. (e.g., depending on which entity is configured to estimate the location of the UE 802). The transmission of the delay information and/or the AoD may be performed by, e.g., the NCR component 198, the transceiver(s) 1422, the cellular baseband processor(s) 1424, and/or the application processor(s) 1406 of the apparatus 1404 in FIG. 14.

In one example, the NCR may further transmit, to the first network entity or the second network entity, capability information related to the NCR, where the configuration is based on the capability information related to the NCR. In some implementations, the capability information of the NCR includes at least a number of beams or a maximum transmission power supported by the NCR.

In another example, the NCR may further receive, from the second network entity, the set of RSs.

In another example, the NCR may further transmit, to the second network entity, an indication of whether the NCR is activated, inactivated, or not active, and receive a request to activate the NCR if the NCR is inactivated or not active.

In another example, the NCR may further receive, from the second network entity, a request to amplify and forward the set of RSs. In some implementations, the request further instructs the NCR to amplify and forward the set of RSs using a same beam that is used for receiving the set of RSs by the NCR.

In another example, the NCR may further receive, from the second network entity, a request to transmit the set of RSs on different beams, where to transmit the set of RSs, the NCR may be configured to transmit the set of RSs on the different beams based on the request.

In another example, the first network entity is an LMF, an NWDAF, or a sensing management function, and where the second network entity is a base station.

FIG. 14 is a diagram 1400 illustrating an example of a hardware implementation for an apparatus 1404. The apparatus 1404 may be a UE/NCR, a component of a UE/NCR, or may implement UE/NCR functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an ultrawide band (UWB) module 1438 (e.g., a UWB transceiver), an SPS module 1416 (e.g., GNSS module), one or more sensors 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the UWB module 1438, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The cellular baseband processor(s) 1424 and the application processor(s) 1406 are configured to perform the various functions described supra based at least in part of the information stored in the memory. That is, the cellular baseband processor(s) 1424 and the application processor(s) 1406 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE/NCR (e.g., see UE 350 of FIG. 3) and include the additional modules of the apparatus 1404.

As discussed supra, the NCR component 198 may be configured to receive, from a first network entity or a second network entity, a configuration for transmitting a set of RSs to a UE. The NCR component 198 may also be configured to transmit the set of RSs to the UE based on the configuration. The NCR component 198 may also be configured to transmit, to the first network entity or the second network entity, at least one of delay information or an AoD associated with transmission of the set of RSs. The NCR component 198 may be within the cellular baseband processor(s) 1424, the application processor(s) 1406, or both the cellular baseband processor(s) 1424 and the application processor(s) 1406. The NCR component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for receiving, from a first network entity or a second network entity, a configuration for transmitting a set of RSs to a UE. The apparatus 1404 may further include means for transmitting the set of RSs to the UE based on the configuration. The apparatus 1404 may further include means for transmitting, to the first network entity or the second network entity, at least one of delay information or an AoD associated with transmission of the set of RSs.

In one configuration, the apparatus 1404 may further include means for transmitting, to the first network entity or the second network entity, capability information related to the NCR, where the configuration is based on the capability information related to the NCR. In some implementations, the capability information of the NCR includes at least a number of beams or a maximum transmission power supported by the NCR.

In another configuration, the apparatus 1404 may further include means for receiving, from the second network entity, the set of RSs.

In another configuration, the apparatus 1404 may further include means for transmitting, to the second network entity, an indication of whether the NCR is activated, inactivated, or not active, and means for receiving a request to activate the NCR if the NCR is inactivated or not active.

In another configuration, the apparatus 1404 may further include means for receiving, from the second network entity, a request to amplify and forward the set of RSs. In some implementations, the request further instructs the NCR to amplify and forward the set of RSs using a same beam that is used for receiving the set of RSs by the NCR.

In another configuration, the apparatus 1404 may further include means for receiving, from the second network entity, a request to transmit the set of RSs on different beams, where the means for transmitting the set of RSs may include configuring the apparatus 1404 to transmit the set of RSs on the different beams based on the request.

In another configuration, the first network entity is an LMF, an NWDAF, or a sensing management function, and the second network entity is a base station.

The means may be the NCR component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S F F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first network entity, comprising: receiving an indication that a network-controlled repeater (NCR) is available for a positioning session of a user equipment (UE); receiving capability information related to the NCR; and transmitting a configuration for transmitting a set of reference signals (RSs) to the UE using the NCR, wherein the configuration is based on availability and capability information of the NCR.

Aspect 2 is the method of aspect 1, further comprising: receiving a second indication of whether the NCR is activated, inactivated, or not active; and transmitting a request to activate the NCR if the NCR is inactivated or not active.

Aspect 3 is the method of aspect 1 or aspect 2, wherein the indication further includes a location of the NCR, and wherein the request to activate the NCR is further based on the location of the NCR.

Aspect 4 is the method of any of aspects 1 to 3, further comprising: initiating a position session for identifying a location of the NCR if the location of the NCR is unknown; and obtaining the location of the NCR based on the positioning session, wherein transmission of the configuration is based on the location of the NCR being known.

Aspect 5 is the method of any of aspects 1 to 4, further comprising: transmitting, to a second network entity, a request to configure the NCR to amplify and forward the set of RSs.

Aspect 6 is the method of any of aspects 1 to 5, wherein the request further instructs the second network entity to configure the NCR to amplify and forward the set of RSs using a same beam that is used for receiving the set of RSs by the NCR.

Aspect 7 is the method of any of aspects 1 to 6, further comprising: transmitting, to the UE, assistance data for receiving the set of RSs from multiple NCRs including the NCR; and receiving, from the UE based on the assistance data, a set of measurements for the set of RSs.

Aspect 8 is the method of any of aspects 1 to 7, further comprising: receiving, from a second network entity or the NCR, at least one of delay information associated with the NCR or a transmission time for transmitting the set of RSs from the NCR; and estimating a position of the UE based on the set of measurements and at least one of the delay information or the transmission time.

Aspect 9 is the method of any of aspects 1 to 8, further comprising: receiving, from a second network entity or the NCR, an angle of departure (AoD) for transmitting the set of RSs by the NCR; and estimating a position of the UE based on the set of measurements and the AoD.

Aspect 10 is the method of any of aspects 1 to 9, wherein the capability information of the NCR includes at least a number of beams or a maximum transmission power supported by the NCR.

Aspect 11 is the method of any of aspects 1 to 10, further comprising: transmitting, to a second network entity, a request to configure the NCR to transmit the set of RSs on different beams.

Aspect 12 is the method of any of aspects 1 to 11, wherein receiving the indication comprises: receiving the indication from a second network entity or the UE.

Aspect 13 is the method of any of aspects 1 to 12, wherein receiving the capability information related to the NCR comprises: receiving the capability information related to the NCR from a second network entity.

Aspect 14 is the method of any of aspects 1 to 13, wherein transmitting the configuration comprises: transmitting the configuration to a second network entity or the NCR.

Aspect 15 is an apparatus for wireless communication at a first network entity, including: at least one memory; and at least one processor coupled to the at least one memory and, based at least in part on stored information that is stored in the at least one memory, the at least one processor, individually or in any combination, is configured to implement any of aspects 1 to 14.

Aspect 16 is the apparatus of aspect 15, further including at least one network interface or at least one transceiver coupled to the at least one processor.

Aspect 17 is an apparatus for wireless communication at a first network entity including means for implementing any of aspects 1 to 14.

Aspect 18 is a computer-readable medium (e.g., a non-transitory computer-readable medium) storing computer executable code, where the code when executed by a processor causes the processor to implement any of aspects 1 to 14.

Aspect 19 is a method of wireless communication at a second network entity, comprising: transmitting, to a first network entity, an indication that a network-controlled repeater (NCR) is available for a positioning session of a user equipment (UE); transmitting, to the first network entity, capability information related to the NCR; and receiving, from the first network entity, a configuration for transmitting a set of reference signals (RSs) to the UE using the NCR, wherein the configuration is based on availability and capability information of the NCR.

Aspect 20 is the method of aspect 19, further comprising: transmitting, based on the configuration, the set of RSs to the NCR.

Aspect 21 is the method of aspect 19 or aspect 20, further comprising: transmitting the configuration to the NCR based on reception of the NCR from the first network entity.

Aspect 22 is the method of any of aspects 19 to 21, further comprising: transmitting, to the first network entity, a second indication of whether the NCR is activated, inactivated, or not active; and receiving, from the first network entity, a request to activate the NCR if the NCR is inactivated or not active.

Aspect 23 is the method of any of aspects 19 to 22, wherein the indication further includes a location of the NCR, and wherein the request to activate the NCR is further based on the location of the NCR.

Aspect 24 is the method of any of aspects 19 to 23, further comprising: receiving, from the first network entity, a request to configure the NCR to amplify and forward the set of RSs; and transmitting, to the NCR based on the request, a second indication to amplify and forward the set of RSs.

Aspect 25 is the method of any of aspects 19 to 24, wherein the request further instructs the second network entity to configure the NCR to amplify and forward the set of RSs using a same beam that is used for receiving the set of RSs by the NCR.

Aspect 26 is the method of any of aspects 19 to 25, further comprising: receiving, from the NCR, at least one of delay information associated with the NCR or an angle of departure (AoD) for transmitting the set of RSs by the NCR; and transmitting, to the first network entity, the delay information or the AoD.

Aspect 27 is the method of any of aspects 19 to 26, wherein the capability information of the NCR includes at least a number of beams or a maximum transmission power supported by the NCR.

Aspect 28 is the method of any of aspects 19 to 27, further comprising: receiving, from the first network entity, a request to configure the NCR to transmit the set of RSs on different beams; and transmitting, to the NCR based on the request, a second indication to transmit the set of RSs on the different beams.

Aspect 29 is the method of any of aspects 19 to 28, wherein the second network entity is a base station, and wherein the first network entity is a location management function (LMF), a network data analytics function (NWDAF), or a sensing management function.

Aspect 30 is an apparatus for wireless communication at a second network entity, including: at least one memory; and at least one processor coupled to the at least one memory and, based at least in part on stored information that is stored in the at least one memory, the at least one processor, individually or in any combination, is configured to implement any of aspects 19 to 29.

Aspect 31 is the apparatus of aspect 30, further including at least one network interface or at least one transceiver coupled to the at least one processor.

Aspect 32 is an apparatus for wireless communication at a second network entity including means for implementing any of aspects 19 to 29.

Aspect 33 is a computer-readable medium (e.g., a non-transitory computer-readable medium) storing computer executable code, where the code when executed by a processor causes the processor to implement any of aspects 19 to 29.

Aspect 34 is a method of wireless communication at a network-controlled repeater (NCR), comprising: receiving, from a first network entity or a second network entity, a configuration for transmitting a set of reference signals (RSs) to a user equipment (UE); transmitting the set of RSs to the UE based on the configuration; and transmitting, to the first network entity or the second network entity, at least one of delay information or an angle of departure (AoD) associated with transmission of the set of RSs.

Aspect 35 is the method of aspect 34, further comprising: transmitting, to the first network entity or the second network entity, capability information related to the NCR, wherein the configuration is based on the capability information related to the NCR.

Aspect 36 is the method of aspect 34 or aspect 35, wherein the capability information of the NCR includes at least a number of beams or a maximum transmission power supported by the NCR.

Aspect 37 is the method of any of aspects 34 to 36, further comprising: receiving, from the second network entity, the set of RSs.

Aspect 38 is the method of any of aspects 34 to 37, further comprising: transmitting, to the second network entity, an indication of whether the NCR is activated, inactivated, or not active; and receiving a request to activate the NCR if the NCR is inactivated or not active.

Aspect 39 is the method of any of aspects 34 to 38, further comprising: receiving, from the second network entity, a request to amplify and forward the set of RSs.

Aspect 40 is the method of any of aspects 34 to 39, wherein the request further instructs the NCR to amplify and forward the set of RSs using a same beam that is used for receiving the set of RSs by the NCR.

Aspect 41 is the method of any of aspects 34 to 40, further comprising: receiving, from the second network entity, a request to transmit the set of RSs on different beams, wherein transmitting the set of RSs comprises transmitting the set of RSs on the different beams based on the request.

Aspect 42 is the method of any of aspects 34 to 41, wherein the first network entity is a location management function (LMF), a network data analytics function (NWDAF), or a sensing management function, and wherein the second network entity is a base station.

Aspect 43 is an apparatus for wireless communication at a network-controlled repeater (NCR), including: at least one memory; and at least one processor coupled to the at least one memory and, based at least in part on stored information that is stored in the at least one memory, the at least one processor, individually or in any combination, is configured to implement any of aspects 34 to 42.

Aspect 44 is the apparatus of aspect 43, further including at least one transceiver or at least one network interface coupled to the at least one processor.

Aspect 45 is an apparatus for wireless communication at a network-controlled repeater (NCR) including means for implementing any of aspects 34 to 42.

Aspect 46 is a computer-readable medium (e.g., a non-transitory computer-readable medium) storing computer executable code, where the code when executed by a processor causes the processor to implement any of aspects 34 to 42.

What is claimed is:

1. An apparatus for wireless communication at a first network entity, comprising:
at least one network interface;
at least one memory; and
at least one processor coupled to the at least one network interface and the at least one memory, wherein the at least one processor is configured to:
receive, via the at least one network interface, an indication that a network-controlled repeater (NCR) is available for a positioning session of a user equipment (UE);
receive, via the at least one network interface, capability information related to the NCR; and
transmit, via the at least one network interface, a configuration for transmitting a set of reference signals (RSs) to the UE using the NCR, wherein the configuration is based on availability and capability information of the NCR.

2. The apparatus of claim 1, wherein the at least one processor is further configured to:
receive a second indication of whether the NCR is activated, inactivated, or not active; and
transmit a request to activate the NCR if the NCR is inactivated or not active.

3. The apparatus of claim 2, wherein the indication further includes a location of the NCR, and wherein the request to activate the NCR is further based on the location of the NCR.

4. The apparatus of claim 1, wherein the at least one processor is further configured to:
initiate a position session for identifying a location of the NCR if the location of the NCR is unknown; and
obtain the location of the NCR based on the positioning session, wherein transmission of the configuration is based on the location of the NCR being known.

5. The apparatus of claim 1, wherein the at least one processor is further configured to:
transmit, to a second network entity, a request to configure the NCR to amplify and forward the set of RSs.

6. The apparatus of claim 5, wherein the request further instructs the second network entity to configure the NCR to amplify and forward the set of RSs using a same beam that is used for receiving the set of RSs by the NCR.

7. The apparatus of claim 1, wherein the at least one processor is further configured to:
transmit, to the UE, assistance data for receiving the set of RSs from multiple NCRs including the NCR; and
receive, from the UE based on the assistance data, a set of measurements for the set of RSs.

8. The apparatus of claim 7, wherein the at least one processor is further configured to:
receive, from a second network entity or the NCR, at least one of delay information associated with the NCR or a transmission time for transmitting the set of RSs from the NCR; and
estimate a position of the UE based on the set of measurements and at least one of the delay information or the transmission time.

9. The apparatus of claim 7, wherein the at least one processor is further configured to:
receive, from a second network entity or the NCR, an angle of departure (AoD) for transmitting the set of RSs by the NCR; and
estimate a position of the UE based on the set of measurements and the AoD.

10. The apparatus of claim 1, wherein the capability information of the NCR includes at least a number of beams or a maximum transmission power supported by the NCR.

11. The apparatus of claim 10, wherein the at least one processor is further configured to:
transmit, to a second network entity, a request to configure the NCR to transmit the set of RSs on different beams.

12. A method of wireless communication at a first network entity, comprising:
receiving an indication that a network-controlled repeater (NCR) is available for a positioning session of a user equipment (UE);
receiving capability information related to the NCR; and
transmitting, a configuration for transmitting a set of reference signals (RSs) to the UE using the NCR, wherein the configuration is based on availability and capability information of the NCR.

13. An apparatus for wireless communication at a second network entity, comprising:
at least one transceiver;
at least one memory; and
at least one processor coupled to the at least one transceiver and the at least one memory, wherein the at least one processor is configured to:
transmit, to a first network entity via the at least one transceiver, an indication that a network-controlled repeater (NCR) is available for a positioning session of a user equipment (UE);
transmit, to the first network entity via the at least one transceiver, capability information related to the NCR; and
receive, from the first network entity via the at least one transceiver, a configuration for transmitting a set of reference signals (RSs) to the UE using the NCR, wherein the configuration is based on availability and capability of the NCR.

14. The apparatus of claim 13, wherein the at least one processor is further configured to:
transmit, based on the configuration, the set of RSs to the NCR.

15. The apparatus of claim 13, wherein the at least one processor is further configured to:
transmit the configuration to the NCR based on reception of the NCR from the first network entity.

16. The apparatus of claim 13, wherein the at least one processor is further configured to:
transmit, to the first network entity, a second indication of whether the NCR is activated, inactivated, or not active; and
receive, from the first network entity, a request to activate the NCR if the NCR is inactivated or not active.

17. The apparatus of claim 16, wherein the indication further includes a location of the NCR, and wherein the request to activate the NCR is further based on the location of the NCR.

18. The apparatus of claim 13, wherein the at least one processor is further configured to:
receive, from the first network entity, a request to configure the NCR to amplify and forward the set of RSs; and
transmit, to the NCR based on the request, a second indication to amplify and forward the set of RSs.

19. The apparatus of claim 18, wherein the request further instructs the second network entity to configure the NCR to amplify and forward the set of RSs using a same beam that is used for receiving the set of RSs by the NCR.

20. The apparatus of claim 13, wherein the at least one processor is further configured to:
receive, from the NCR, at least one of delay information associated with the NCR or an angle of departure (AoD) for transmitting the set of RSs by the NCR; and
transmit, to the first network entity, the delay information or the AoD.

21. The apparatus of claim 13, wherein the capability information of the NCR includes at least a number of beams or a maximum transmission power supported by the NCR.

22. The apparatus of claim 21, wherein the at least one processor is further configured to:
receive, from the first network entity, a request to configure the NCR to transmit the set of RSs on different beams; and
transmit, to the NCR based on the request, a second indication to transmit the set of RSs on the different beams.

23. An apparatus for wireless communication at a network-controlled repeater (NCR), comprising:
at least one transceiver;
at least one memory; and
at least one processor coupled to the at least one memory, wherein the at least one processor is configured to:
receive, from a first network entity or a second network entity via the at least one transceiver, a configuration for transmitting a set of reference signals (RSs) to a user equipment (UE);
transmit, via the at least one transceiver, the set of RSs to the UE based on the configuration; and
transmit, to the first network entity or the second network entity via the at least one transceiver, at least one of delay information or an angle of departure (AoD) associated with transmission of the set of RSs.

24. The apparatus of claim 23, wherein the at least one processor is further configured to:
transmit, to the first network entity or the second network entity, capability information related to the NCR, wherein the configuration is based on the capability information related to the NCR.

25. The apparatus of claim 24, wherein the capability information of the NCR includes at least a number of beams or a maximum transmission power supported by the NCR.

26. The apparatus of claim 23, wherein the at least one processor is further configured to:
receive, from the second network entity, the set of RSs.

27. The apparatus of claim 23, wherein the at least one processor is further configured to:
transmit, to the second network entity, an indication of whether the NCR is activated, inactivated, or not active; and
receive a request to activate the NCR if the NCR is inactivated or not active.

28. The apparatus of claim 23, wherein the at least one processor is further configured to:
receive, from the second network entity, a request to amplify and forward the set of RSs.

29. The apparatus of claim 28, wherein the request further instructs the NCR to amplify and forward the set of RSs using a same beam that is used for receiving the set of RSs by the NCR.

30. The apparatus of claim 23, wherein the at least one processor is further configured to:
receive, from the second network entity, a request to transmit the set of RSs on different beams, wherein transmitting the set of RSs comprises transmitting the set of RSs on the different beams based on the request.
